(19) United States
(12) Patent Application Publication
(10) Pub. No.: US 2015/0043686 A1
(43) Pub. Date: Feb. 12, 2015

(54) Methods and Systems for Channel Estimation

(71) Applicant: Amlogic Co., Ltd., Santa Clara, CA (US)

(72) Inventors: Jinhong Zhang, Santa Clara, CA (US); Jin Niu, Shanghai (CN)

(73) Assignee: Amlogic Co., Ltd., Santa Clara, CA (US)

(21) Appl. No.: 13/962,160

(22) Filed: Aug. 8, 2013

(51) Int. Cl. H04L 25/02; H04B 1/10

(52) U.S. Cl. CPC H04L 25/0212; H04B 1/1081
USPC 375/348

(57) ABSTRACT

A method for channel estimation of a signal by a receiver, comprises the steps of: receiving a symbol of the signal, wherein the signal has a cyclic prefix (“CP”); combining a portion of the CP and an end portion of the symbol; and processing the combined symbol for channel estimation by the receiver.

### FIELD OF INVENTION

This invention relates to methods and systems for channel estimation for communication systems, and, in particular, to methods and systems for orthogonal frequency divisional multiplexing (“OFDM”) channel estimation.

### BACKGROUND

In a communications system, a transmitter sends data to a receiver through a channel. In the case of a wireless channel, the transmitted waveforms suffer from multipath fading due to reflection, refraction, and diffraction, which ultimately results in inter-symbol-interference (“ISI”) between transmitted symbols. This is particularly problematic for modern broadband wireless communications systems, e.g., OFDM systems, which offer high data rate services. Particularly for such high data rate systems, multipath fading is especially difficult to mitigate.

Many current communications systems mitigate ISI by using a cyclic prefix (“CP”) for each transmitted symbol. The CP is a copy of the latter portion of a transmitted symbol that is prepended to the transmitted symbol. The CP acts as a buffer region where delayed information for the previous symbol can be stored by the receiver. The receiver has to exclude all the samples from the CP since those samples can be corrupted by the previous symbol. Furthermore, the CP interval can vary to accommodate different multipath environments. Typically, the CP interval is determined by the expected duration of the multipath channel in the operating environment. As such, a DVB-T system has been configured to have four different CP intervals, including ¼, ⅛, 1/16 and 1/32 of the FFT length.

FIG. 1 illustrates a symbol for an OFDM signal having a cyclic prefix. A symbol 10 can have a CP 12 having Ncp points and a body 14 having N points. The CP 12 is a copy of a latter portion 16 of the body 14 of the symbol 10. The drawback of using the CP is that a loss in data rate occurs since redundant information is conveyed. Since the CP is a buffer to avoid ISI, the CP is discarded after receiving the symbol 10. Therefore, it is desirable to provide new methods and systems that can use the CP of a signal to improve the reception of the signal.

### SUMMARY OF INVENTION

An object of this invention is to provide methods and systems for channel estimation that can improve sensitivity without sacrificing multipath mitigation.

Another object of this invention is to provide methods and systems for using a cyclic prefix of a signal to improve channel estimation of the signal.

Yet another object of this invention is to provide methods and systems to suppress noise of a signal by using a cyclic prefix of the signal.

Briefly, the present invention discloses methods for channel estimation of a signal by a receiver, comprising the steps of: receiving a symbol of the signal, wherein the signal has a cyclic prefix; combining a portion of the CP and an end portion of the symbol; and processing the combined symbol for channel estimation by the receiver.

An advantage of this invention is that methods and systems for channel estimation that can improve sensitivity without sacrificing multipath mitigation are provided.

Another advantage of this invention is that methods and systems for using a cyclic prefix of a signal to improve channel estimation of the signal are provided.

Yet another advantage of this invention is that methods and systems to suppress noise of a signal by using a cyclic prefix of the signal are provided.

### DESCRIPTION OF THE DRAWINGS

The foregoing and other objects, aspects, and advantages of the invention can be better understood from the following detailed description of the preferred embodiment of the invention when taken in conjunction with the accompanying drawings in which:

FIG. 1 illustrates a symbol for an OFDM signal having a cyclic prefix.

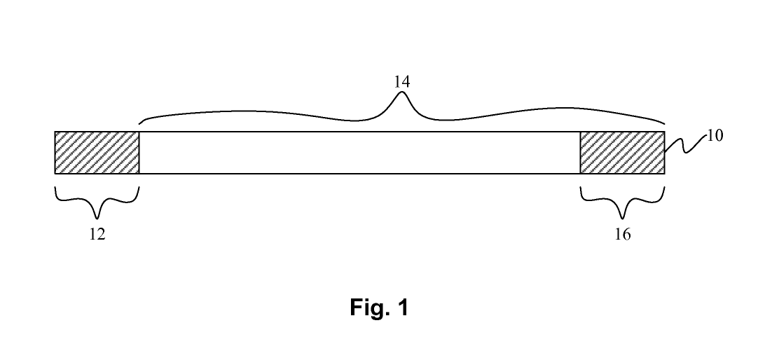

FIG. 2 illustrates a symbol of the present invention for an OFDM signal having a cyclic prefix.

FIG. 3 illustrates a method of the present invention for channel estimation of a signal.

FIG. 4 illustrates a graph of a noise suppressed channel impulse response power versus samples of a symbol for showing a multipath delay spread.

FIG. 5 illustrates a block diagram for a communications system of the present invention.

### DETAILED DESCRIPTION OF THE PREFERRED EMBODIMENTS

In the following detailed description of the embodiments, reference is made to the accompanying drawings, which form a part hereof, and in which is shown by way of illustration of specific embodiments in which the present invention may be practiced.

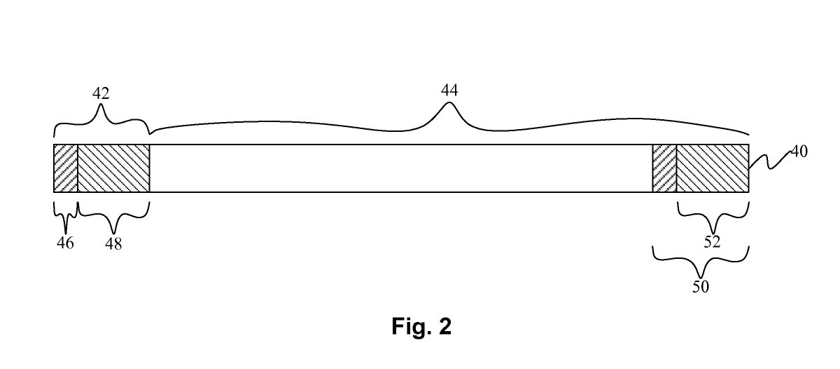

FIG. 2 illustrates a symbol of the present invention for an OFDM signal having a cyclic prefix. A symbol 40 can have a CP 42 having Ncp sampling points and a body 44 having N sampling points. Thus, Ncp is the length of the cyclic prefix 42 and N is the length of the body 44 of the symbol. The CP 42 is a copy of a latter portion 50 of the body of the symbol. If the multipath channel delay spread is small, then only some of the CP 42 is affected and unreliable due to ISI. This portion can be referred to as the affected portion 46 and can have a length of Ndly points. The remainder of the cyclic prefix 42 is unaffected and presumably reliable. The unaffected portion 48 can be referred to as the unaffected portion 48, which can also be denoted R1. The unaffected portion 48 can be obtained by subtracting the Ncp points with the Ndly points. Generally, the Ncp points are usually known ahead of time and the Ndly points can be estimated as outlined below.

Since the unaffected portion 48 is presumed to be reliable, the unaffected portion 48 can be used during channel estimation by a receiver of the respective signal to improve the receiver performance. For instance, the unaffected portion 48 of the CP 42 can be used to strengthen a portion 52 of the symbol 40 by averaging the two sets of samples to get a strengthened portion of the body 44. This is due in fact that the CP 42 is a duplicate of the latter portion 50. Thus, the unaffected portion 48 of the CP 42 can be lined up with its counterpart in the latter portion 50, i.e., the portion 52, and then averaged to provide a strengthened signal at the portion 52.

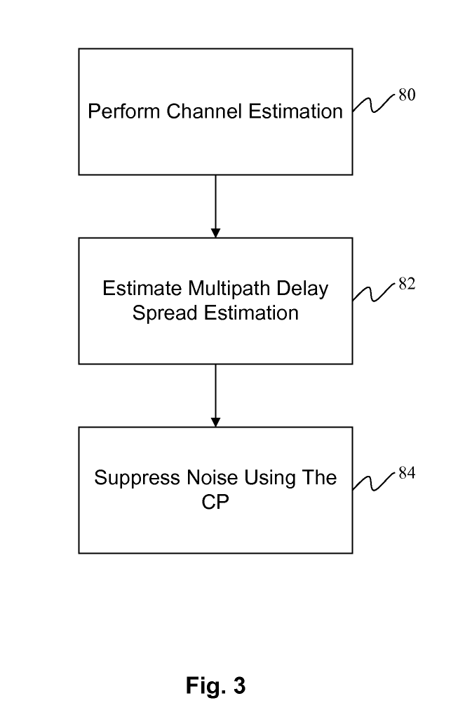

FIG. 3 illustrates a method of the present invention for channel estimation of a signal. Channel estimation can be performed 80 by obtaining a noise suppressed channel impulse response power (“CIRP”). To obtain the CIRP, a channel impulse response (“CIR”) for the channel is obtained, e.g., according to Equation (1). Next, the CIR is used to calculate the CIRP of the channel, e.g., according to Equation (2). Finally, the CIRP can be filtered by nulling any values for the CIRP lower than a threshold value, giving a |h₁[n]|² function to represent the CIRP, see Equation (3). The threshold value can be determined based on empirical methods. Typically, the threshold value can be set to equal 0.001 multiplied by the sum of all of the CIRP.

h=ifft(H) Equation (1)

where H is the channel frequency response, h is the channel impulse response, and ifft is the Inverse Fast Fourier Transform function.

$${\vert h [ n ] \vert}^{2} = h [ mod ( n - \frac{N}{2} , N ) ] * {h [ mod ( n - \frac{N}{2} , N ) ]}^{*} \qquad Equation ( 2 )$$

where N>=n>=0, mod is the modulo operator, and N is the total number of samples of the symbol.

$${\vert {h}_{1} [ n ] \vert}^{2} = \{ \begin{matrix}{\vert h [ n ] \vert}^{2} , & {\vert h [ n ] \vert}^{2} > threshold \\ 0 , & {\vert h [ n ] \vert}^{2} \leq threshold\end{matrix} \qquad Equation ( 3 )$$

The next step is to estimate the multipath delay spread 82. In order to do this, a first path position for the calculated CIRP and a last path position for the calculated CIRP are determined, see Equations (4) and (5). The number of samples between the last path position and the first path position can be denoted as the Ndly value and found by Equation (6). Thus, Ncp-Ndly provides the samples of the CP data (i.e., the R1 data 48 as shown in FIG. 2) that are presumably not affected by ISI.

$$\begin{matrix}firstpathpos = arg {min}_{n} {\vert {h}_{1} [ n ] \vert}^{2} > 0 & Equation ( 4 ) \\ lastpathpos = arg {min}_{n} {\vert {h}_{1} [ n ] \vert}^{2} > 0 & Equation ( 5 ) \\ Ndly = lastpathpos - firstpathpos & Equation ( 6 )\end{matrix}$$

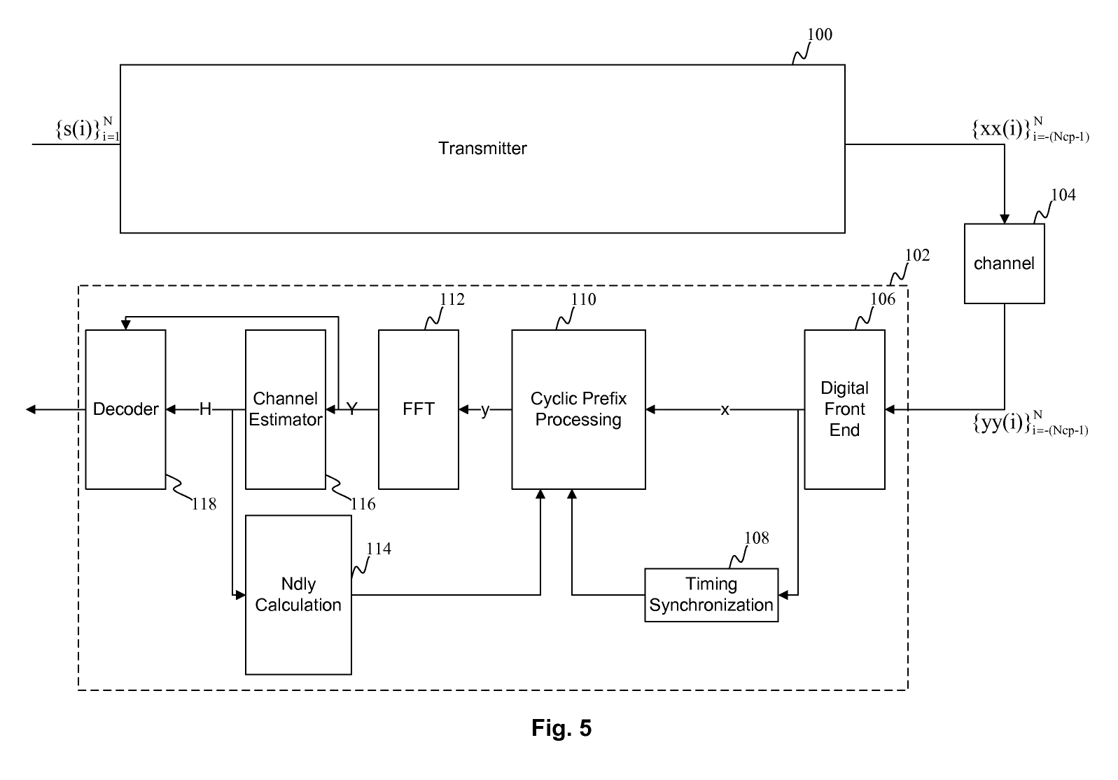

The CP can then be used to suppress noise 84 by reusing the R1 data to strengthen the latter portion of the body of the respective symbol for channel estimation. For instance, during channel estimation, the points Ncp-Ndly and the latter portion of a symbol can be averaged to provide a more reliable sample points for the latter portion of a symbol, e.g., see Equation (7).

$$y [ n ] = \{ \begin{matrix}x [ n + Ncp ] & n < N - ( Ncp - Ndly ) \\ ( x [ n + Ncp ] + x [ n + Ncp - N ] ) / 2 & others\end{matrix} \qquad Equation ( 7 )$$

where n=0,1,2, . . . N−1 and the received signal is represented by a digital signal function x (which is further described in FIG. 5).

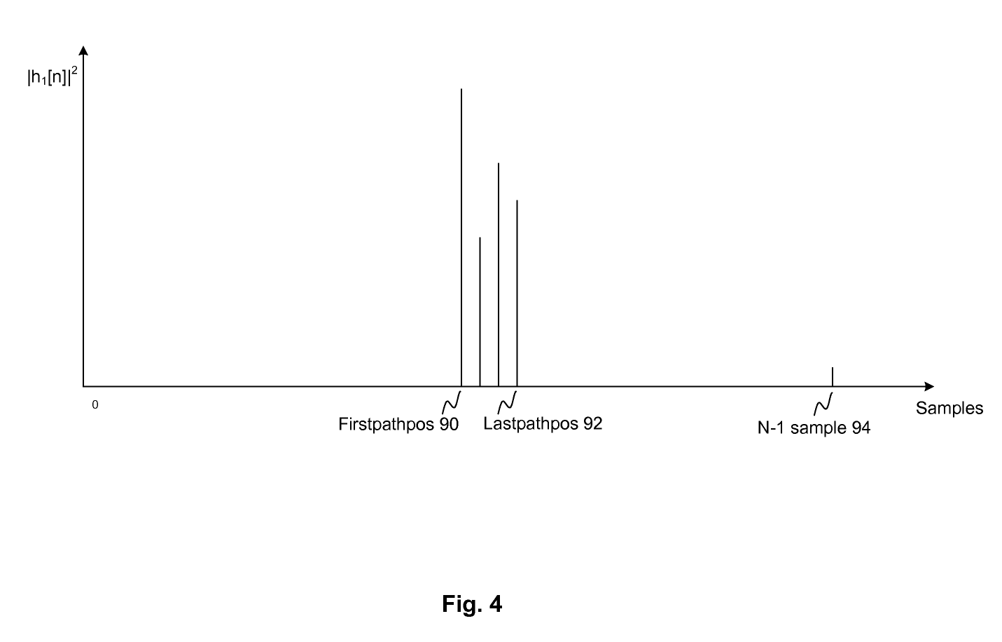

FIG. 4 illustrates a graph of a noise suppressed channel impulse response power versus samples of a symbol for showing a multipath delay spread. In an example, a firstpathpos 90 can be found according to Equation (4) and a lastpathpos 92 can be found according to Equation (5). The firstpathpos 90 and the lastpathpos 92 can be plotted on a graph of a noise suppressed channel impulse response power versus samples of a symbol. The multipath delay spread Ndly can be given in terms of the sampling points by the difference of the lastpathpos 92 and the firstpathpos 90, see Equation (6).

FIG. 5 illustrates a block diagram for a communications system of the present invention. A signal is inputted to a transmitter 100 for transmission over a channel 104, e.g., over-the-air wireless channel. The transmission is received by a receiver 102 for processing and decoding.

The receiver 102 can comprise a digital front end block 106, a timing synchronization block 108, a CP processing block 110, a Fast Fourier Transform (“FFT”) block 112, a channel estimator 116, a Ndly calculation block 114, and a decoder 118. The received analog transmission can be processed by the digital front end block 106 for outputting a digital signal x with a certain sampling rate that is ready for baseband processing. The digital signal x is outputted to the CP processing block 110 and the timing synchronization block 108. The timing synchronization block 108 can estimate timing, frequency, and/or phase errors for the digital signal x and make any corrections as necessary.

The CP processing block 110 receives the digital signal x and an estimated Ndly value from the Ndly calculation block 114 to remove the CP from the digital signal x. The CP can also be used to strengthen the latter portion of the digital signal x. Particularly, the CP processing block 110 can use the Ndly value to calculate the unaffected portion of the CP from ISI. The unaffected portion of the CP can be averaged with its counterpart at the end of a respective symbol to strengthen the signal. The CP processing block 110 outputs the strengthened signal y to the FFT block 112. The FFT block y performs a FFT operation on the strengthened signal y to covert the time domain signal to a frequency domain signal Y. The signal Y is outputted to the channel estimator 116 and the decoder 118.

The channel estimator 116 performs channel estimation on the signal Y to generate a channel frequency response H, which is outputted to the decoder 118 and the Ndly calculation block 114. The Ndly calculation block 114 then can calculate the Ndly value based upon the channel frequency response H, as outlined above. The decoder then decodes the signal Y using the channel frequency response H.

While the present invention has been described with reference to certain preferred embodiments or methods, it is to be understood that the present invention is not limited to such specific embodiments or methods. Rather, it is the inventor's contention that the invention be understood and construed in its broadest meaning as reflected by the following claims. Thus, these claims are to be understood as incorporating not only the preferred apparatuses, methods, and systems described herein, but all those other and further alterations and modifications as would be apparent to those of ordinary skilled in the art.

1. A method for channel estimation of a signal by a receiver, comprising the steps of:
receiving a symbol of the signal, wherein the signal has a cyclic prefix (“CP”), wherein the CP has an affected portion and an unaffected portion, wherein the affected portion of the CP is affected by inter-symbol-interference (“ISI”), and wherein the unaffected portion of the CP is not affected by the ISI;
averaging the unaffected portion of the CP and an end portion of the symbol to generate a combined symbol; and
processing the combined symbol for channel estimation by the receiver.

2. The method of claim 1 wherein the affected portion of the CP is determined as a function of a multipath delay spread for the signal.

3. The method of claim 2 wherein the multipath delay spread is calculated as a function of a channel impulse response (“CIR”) for the signal.

4. The method of claim 3 wherein a channel impulse response power (“CIRP”) is calculated as a function of the CIR, and wherein if the calculated CIRP is equal to or below a predefined threshold, then the CIRP is given a null value.

5. The method of claim 4 wherein a first path position is determined as a function of the CIRP and a last path position is determined as a function of the CIRP, and wherein the multipath delay spread is determined as a function of the first path position and the last path position.

6. The method of claim 2 wherein a first path position is determined as a function of a channel impulse response power (“CIRP”) and a last path position is determined as a function of the CIRP, and wherein the multipath delay spread is determined as a function of the first path position and the last path position.

7. The method of claim 6 wherein, the unaffected portion of the CP starts from an initial sampling point of the CP to an end of the multipath delay spread, and wherein the multipath delay spread is equal to the last path position minus the first path position.

8. The method of claim 6 wherein the combined symbol y[n] is
$$y [ n ] = \{ \begin{matrix}x [ n + Ncp ] & n < N - ( Ncp - Ndly ) \\ ( x [ n + Ncp ] + x [ n + Ncp - N ] ) / 2 & others\end{matrix} ,$$
where Ncp is a total number of sampling points for the CP, Ndly is a multipath delay spread for the signal, N is a total number of sampling points for a body of the symbol, and x is a digital signal function for the received symbol, and wherein the affected portion of the CP is from an initial sampling point of the CP to an end of the multipath delay spread.

9. A method for channel estimation of an orthogonal frequency divisional multiplexing (“OFDM”) signal by a receiver, comprising the steps of:
receiving a symbol of the OFDM signal, wherein the OFDM signal has a cyclic prefix (“CP”), wherein the CP has an affected portion and an unaffected portion, wherein the affected portion of the CP is affected by inter-symbol-interference (“ISI”), and wherein the unaffected portion of the CP is not affected by the ISI;
averaging the unaffected portion of the CP and an end portion of the symbol to generate a combined symbol, wherein the affected portion of the CP is determined as a function of a multipath delay spread for the signal, and wherein the multipath delay spread is calculated as a function of a channel impulse response (“CIR”) for the signal; and
processing the combined symbol for channel estimation by the receiver.

10. The method of claim 9 wherein a channel impulse response power (“CIRP”) is calculated as a function of the CIR, and wherein if the calculated CIRP is equal to or below a predefined threshold, then the CIRP is given a null value.

11. The method of claim 10 wherein a first path position is determined as a function of the CIRP and a last path position is determined as a function of the CIRP, [[and]] wherein the multipath delay spread is determined as a function of the first path position and the last path position, wherein the unaffected portion of the CP starts from an initial sampling point of the CP to an end of the multipath delay spread, and wherein the multipath delay spread is equal to the last path position minus the first path position.

12. The method of claim 9 wherein a first path position is determined as a function of a channel impulse response power (“CIRP”) and a last path position is determined as a function of the CIRP, wherein the multipath delay spread is determined as a function of the first path position and the last path position, wherein the unaffected portion of the CP starts from an initial sampling point of the CP to an end of the multipath delay spread, and wherein the multipath delay spread is equal to the last path position minus the first path position.

13. The method of claim 9 wherein the combined symbol y[n] is
$$y [ n ] = \{ \begin{matrix}x [ n + Ncp ] & n < N - ( Ncp - Ndly ) \\ ( x [ n + Ncp ] + x [ n + Ncp - N ] ) / 2 & others\end{matrix} ,$$
where Ncp is a total number of sampling points for the CP, Ndly is a multipath delay spread for the signal, N is a total number of sampling points for a body of the symbol, and x is a digital signal function for the received symbol, and wherein the affected portion of the CP is from an initial sampling point of the CP to an end of the multipath delay spread.

14. A method for channel estimation of an orthogonal frequency divisional multiplexing (“OFDM”) signal by a receiver, comprising the steps of:
receiving a symbol of the OFDM signal, wherein the OFDM signal has a cyclic prefix (“CP”), wherein the CP has an affected portion and an unaffected portion, wherein the affected portion of the CP is affected by inter-symbol-interference (“ISI”), and wherein the unaffected portion of the CP is not affected by the ISI;
averaging the unaffected portion of the CP and an end portion of the symbol to generate a combined symbol, wherein the affected portion of the CP is determined as a function of a multipath delay spread for the signal, wherein the multipath delay spread is calculated as a function of a channel impulse response (“CIR”) for the signal, and wherein the unaffected portion of the CP starts from an initial sampling point of the CP to an end of the multipath delay spread, and wherein the multipath delay spread is equal to the last path position minus the first path position; and
processing the combined symbol for channel estimation by the receiver,
wherein a first path position is determined as a function of a channel impulse response power (“CIRP”) and a last path position is determined as a function of the CIRP,
wherein the multipath delay spread is determined as a function of the first path position and the last path position, and
wherein the combined symbol y[n] is
$$y [ n ] = \{ \begin{matrix}x [ n + Ncp ] & n < N - ( Ncp - Ndly ) \\ ( x [ n + Ncp ] + x [ n + Ncp - N ] ) / 2 & others\end{matrix} ,$$
wherein Ncp is a total number of sampling points for the CP, Ndly is a multipath delay spread for the signal, N a total number of is sampling points for a body of the symbol, and x is a digital signal function for the received symbol, and
wherein the affected portion of the CP is from an initial sampling point of the CP to an end of the multipath delay spread.
